(19) United States
(12) Patent Application Publication
(10) Pub. No.: US 2026/0169185 A1
(43) Pub. Date: Jun. 18, 2026

(54) METHOD, SYSTEM, DEVICE, AND MEDIUM FOR CALCULATING TEMPERATURE DISTRIBUTION IN IN-SITU ELECTRICAL HEATING OF RESERVOIR

(71) Applicant: Southwest petroleum university, Chengdu (CN)

(72) Inventors: Jiang Jia, Chengdu (CN); Runqi Guo, Chengdu (CN); Jinman Qiu, Chengdu (CN); Tianhao Wan, Chengdu (CN); Siyu Liang, Chengdu (CN)

(21) Appl. No.: 19/292,929

(22) Filed: Aug. 7, 2025

(30) Foreign Application Priority Data
Sep. 13, 2024 (CN) 202411280732.0

(51) Int. Cl. G01V 9/00; E21B 36/04; E21B 47/07

(52) U.S. Cl. CPC G01V 9/005; E21B 36/04; E21B 47/07

(57) ABSTRACT

The present invention belongs to the technical field of oil and gas field development. Disclosed are a method, system, device, and medium for calculating temperature distribution in in-situ electrical heating of a reservoir, comprising: establishing a physical formation model of a near-wellbore zone formation; constructing a mathematical physics equation for heat conduction and convection phenomena based on said model and energy conservation law; calculating oil-phase flow velocity data within said physical formation model; calculating internal heat source intensity distribution data from in-situ heating therein; substituting said oil-phase flow velocity data and said internal heat source intensity distribution data into said equation, acquiring formation temperature distribution data via integral solving. The technical solution of the present invention improves the accuracy and reliability of temperature distribution calculation.

### TECHNICAL FIELD

The present disclosure pertains to the field of oil and gas field development, and specifically to a method, system, device, and medium for calculating temperature distribution in in-situ electrical heating of a reservoir.

### BACKGROUND

Reservoir in-situ electrical heating involves placing a heater downhole and conducting instrument-generated electrical current into the formation, causing formation rocks to absorb energy and increase in temperature. The heated formation is typically characterized by organic-rich but low-maturity strata, wherein organic matter undergoes pyrolysis reactions during energy absorption and heating, generating readily extractable oil and gas. Current research on in-situ electrical heating has not fully accounted for the impact of visco-skin on temperature distribution.

### SUMMARY

The objective of the present disclosure is to provide a method, system, device, and medium for calculating temperature distribution in in-situ electrical heating of a reservoir, to address the deficiencies in the existing art identified above.

To achieve this objective, the present disclosure provides a method for calculating temperature distribution in in-situ electrical heating of a reservoir, the method comprising: establishing a physical formation model of a formation in a near-wellbore zone; constructing a mathematical physics equation for heat conduction and convection phenomena in the formation based on said physical formation model and in accordance with the law of energy conservation; calculating oil-phase flow velocity data within said physical formation model; calculating internal heat source intensity distribution data generated by in-situ electrical heating within said physical formation model; substituting said oil-phase flow velocity data and said internal heat source intensity distribution data into said mathematical physics equation, and acquiring temperature distribution data of the formation through integral solving.

Optionally, establishing the physical formation model of the formation in the near-wellbore zone comprises: determining model construction parameters, wherein said model construction parameters comprise geometric dimensions, boundary conditions, and physical properties of formation materials in the near-wellbore zone; constructing said physical formation model based on the determined model construction parameters.

Optionally, constructing the mathematical physics equation for heat conduction and convection phenomena in the formation based on said physical formation model and in accordance with the law of energy conservation employs the following formula:

$$ρ c \frac{\partial T}{\partial t} + {ρ}_{o} {c}_{o} \vec{{v}_{o}} ∇ T = ∇ \cdot ( k ∇ T ) + Q$$

where ρ is formation rock density, c is formation rock specific heat capacity, T is formation temperature after heating time t, ρₒ is oil density, cₒ is oil specific heat capacity, \vec{vₒ} is oil-phase flow velocity, k is thermal conductivity, and Q is internal heat source intensity of the formation, with the physical meaning of heat absorbed per unit volume per unit time.

Optionally, calculating oil-phase flow velocity data within said physical formation model specifically comprises:

$$\vec{{v}_{o}} = \frac{p ( r ) - {p}_{w}}{p ( r )} \times {u}_{o}$$

where \vec{vₒ} is oil-phase flow velocity, p(r) is pressure distribution in the radial direction, p_{w} is pressure at the wellbore, and uₒ is Darcy flow velocity.

Optionally, calculating internal heat source intensity distribution data generated by in-situ electrical heating within said physical formation model comprises: determining conductivity distribution data and electric potential distribution data in radial direction, cross-section, and longitudinal section within said physical formation model; calculating energy distribution data generated in radial direction, cross-section, and longitudinal section within said physical formation model based on said electrical conductivity distribution data and said electric potential distribution data; performing surface and volume integration on the calculated energy distribution data to obtain internal heat source intensity distribution data in space within said physical formation model.

A temperature distribution calculation system for in-situ electrical heating of a reservoir, comprising: a model construction module configured to establish a physical formation model of a formation in a near-wellbore zone; and constructing a mathematical physical equation for heat conduction and heat convection phenomena in the formation based on said physical formation model and the law of energy conservation: a parameter calculation module configured to calculate oil-phase flow velocity data within said physical formation model and calculate internal heat source intensity distribution data generated by in-situ electrical heating within said physical formation model; a temperature distribution calculation module, configured to substitute said oil-phase flow velocity data and said internal heat source intensity distribution data into said mathematical physics equation, and acquire temperature distribution data of the formation through integral solving.

An electronic device comprising a memory and a processor, wherein said memory is configured to store a computer program, and said processor is configured to execute said computer program to cause said electronic device to perform said method for calculating temperature distribution in in-situ electrical heating of a reservoir.

A computer-readable storage medium storing a computer program which, when executed by a processor, implements said method for calculating temperature distribution in in-situ electrical heating of a reservoir.

The technical effects of the present invention are as follows: the temperature distribution calculation method provided by the invention incorporates heat conduction and heat convection phenomena in the formation during in-situ electrical heating, rendering the temperature distribution calculation more comprehensive and accurate. This approach more authentically reflects heat transfer processes within the formation. Grounded in the law of energy conservation, the method establishes a convection-heat conduction equation. By strictly adhering to physical principles, the invention ensures the rationality and scientific validity of computational results. Furthermore, by integrating the impact of the visco-skin effect on temperature distribution, it derives formulas to calculate temperature distribution and variations, thereby enhancing the precision and reliability of temperature distribution calculations. This advancement provides critical references and support for energy development and geological exploration.

### BRIEF DESCRIPTION OF DRAWINGS

To more clearly illustrate technical solutions in embodiments of the present invention or the prior art, the following briefly introduces the drawings required for describing the embodiments. Obviously, the drawings in the following description represent only certain embodiments of the present invention. For those skilled in the art, other drawings may be derived from these illustrations without creative effort.

The drawings constituting a part of this application serve to provide further understanding of the application. The illustrative embodiments and their descriptions shall not be construed as unduly limiting the application.

FIG. 1 depicts an implementation flowchart of an embodiment of the present invention;

FIG. 2(a) shows a three-dimensional physical model of an embodiment;

FIG. 2(b) shows a two-dimensional vertical cross-section physical model of an embodiment;

FIG. 3 depicts a schematic diagram of vertical cross-section temperature distribution of an embodiment;

FIG. 4 depicts a schematic diagram of radial temperature distribution of an embodiment;

FIG. 5 depicts a time-temperature curve plot of an embodiment.

### DETAILED DESCRIPTION OF EMBODIMENTS

Various exemplary embodiments of the present invention are described in detail herein. This detailed description should not be construed as limiting the invention but should be understood as providing a more detailed elucidation of certain aspects, features, and implementations of the invention.

It should be understood that the terms used herein are for the purpose of describing particular embodiments only and are not intended to limit the scope of the invention. Furthermore, for any numerical range recited herein, it should be expressly recognized that every intermediate value between the upper and lower limits of such range is specifically disclosed. Every smaller range between any stated value or intermediate value within a stated range and any other stated or intermediate value within said range is also encompassed within the invention. The upper and lower limits of these smaller ranges may be independently included or excluded in the range.

Unless otherwise specified, all technical and scientific terms used herein possess the same meanings as commonly understood by one of ordinary skill in the technical field to which this invention pertains. Although only preferred methodologies are described herein, any methods substantially similar or equivalent to those disclosed may be used in the practice or testing of the invention. All publications mentioned herein are incorporated by reference for the purpose of disclosing and describing methodologies related to such publications. In the event of conflict between any incorporated publication and this specification, the content of this specification shall prevail.

Various modifications and variations may be made to the specific implementations described in this specification without departing from the scope or spirit of the invention. Such adaptations will be readily apparent to those skilled in the art. Other embodiments derived from the teachings of this specification will be obvious to practitioners of the technology. The description and examples herein are exemplary only.

Regarding terms used throughout this document such as “comprising”, “including”, “having”, and “containing”—these are open-ended expressions that mean ‘including, but not limited to’.

It should be noted that, in the absence of conflict, features across different embodiments in this application may be mutually combined. The invention will now be described in detail with reference to the accompanying drawings and in conjunction with specific embodiments.

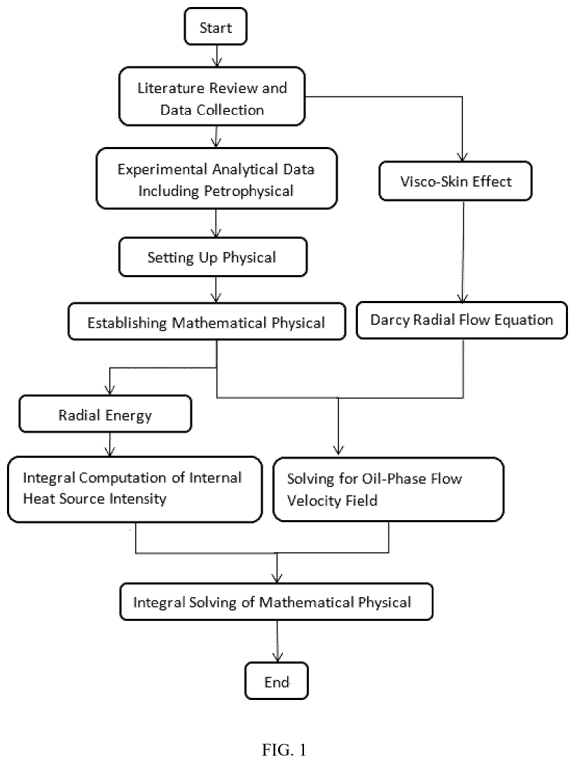

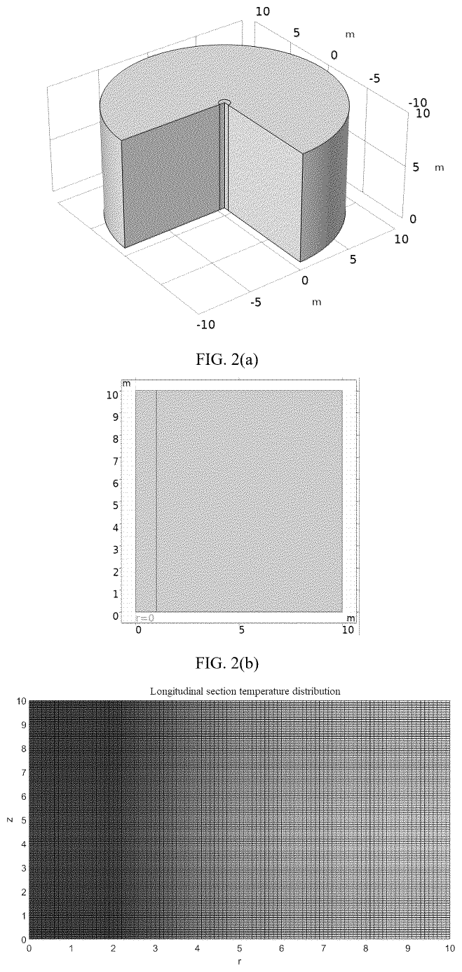

As shown in FIG. 1 to FIGS. 5, this embodiment provides a method for calculating temperature distribution in in-situ electrical heating of a reservoir, comprising: establishing a physical formation model of a formation in a near-wellbore zone; constructing a for heat conduction and heat convection phenomena in the formation based on said physical formation model and the law of energy conservation; calculating oil-phase flow velocity data within said physical formation model; calculating internal heat source intensity distribution data generated by in-situ electrical heating within said physical formation model; substituting said oil-phase flow velocity data and internal heat source intensity distribution data into said mathematical physics equation, and acquiring temperature distribution data of the formation through integral solving.

This embodiment provides a temperature distribution calculation method accounting for visco-skin effects during in-situ electrical heating. During in-situ electrical heating, while accounting for heat conduction and convection phenomena in the formation and computing temperature distribution based on the law of energy conservation and a convection-heat conduction equation, the method develops formulas to calculate temperature distribution and variation under the influence of visco-skin.

The specific implementation flow of this embodiment includes:
(1) Setting a physical model: According to actual requirements, formation physical models of different dimensions and types may be established, including but not limited to: three-dimensional cylindrical and rectangular models, two-dimensional cross-sectional and longitudinal section models. This embodiment uses a longitudinal section of a three-dimensional cylindrical model as an example.
(2) Establishing a mathematical physics equation: During in-situ electrical heating, heat conduction and convection phenomena occur in the formation. Based on the law of energy conservation, a convection-heat conduction equation is used to calculate the formation temperature distribution:

$$ρ c \frac{\partial T}{\partial t} + {ρ}_{o} {c}_{o} \vec{{v}_{o}} ∇ T = ∇ \cdot ( k ∇ T ) + Q$$

where T is temperature of the formation after heating time t, (unit: ° C.); Q is internal heat source intensity of the formation (unit: W/m³); physically representing heat absorbed per unit volume per unit time; ρ is density of formation rock (unit: g/cm³); c is specific heat capacity of formation rock (unit: J/kg·° C.); ρₒ is oil density (unit: g/cm³); cₒ is specific heat capacity of oil (unit: J/kg·° C.); \vec{vₒ} is oil-phase velocity (unit: m/s); k is thermal conductivity (unit: W/m·K).
(3) Oil-Phase Velocity Solution: The concept of visco-skin is used to describe the variation pattern of heavy oil viscosity with pressure. The cause of viscosity change is that gaseous substances dissolved in the heavy oil escape as pressure decreases, leading to reduced fluidity of the heavy oil and forming a visco-skin at the wellbore.

It is postulated that the amount of gas dissolved in heavy oil significantly affects oil viscosity, while the volume of free gas in the heavy oil reservoir exerts minimal influence on pressure distribution; under steady-state reservoir conditions, the pressure distribution may be derived as follows:

$$p ( r ) = {p}_{w} + \frac{ln \frac{r}{{r}_{w}}}{ln \frac{{r}_{e}}{{r}_{w}}} ( {p}_{e} - {p}_{w} )$$

where p(r) is pressure distribution in the radial direction (unit: MPa); p_{w} is pressure at the wellbore (unit: MPa); pₑ is pressure at the drainage radius (unit: MPa); r is radial distance (unit: m); r_{w} is wellbore radius (unit: m); and rₑ is drainage radius (unit: m).

According to the Darcy radial flow formula, radial Darcy flow velocity distribution is obtained through the separation of variables and integrating from the wellbore radius to the drainage radius:

$${Q}_{o} = \frac{2 π {Kh ( p ( r ) - {p}_{w} )}^{2}}{{μ}_{DO} ln \frac{{r}_{e}}{{r}_{w}}} \cdot f ( {P}_{μ} )$$

$$f ( {P}_{μ} ) = \frac{ln ( {P}_{μ} )}{{P}_{μ}^{- \frac{{p}_{w}}{p ( r )}} - {P}_{μ}^{- 1}} \cdot \frac{1}{p ( r )}$$

$${P}_{μ} = \frac{{μ}_{DO}}{{μ}_{LO}}$$

where Qₒ is Darcy flow velocity distribution in the radial direction (unit: m/s); K is permeability (unit: mD); h is model height (unit: m); μ_{DO} is oil viscosity at the wellbore (unit: mPa·s); μ_{LO} is oil viscosity at the drainage radius (unit: mPa·s); and P_{μ} is a viscosity parameter (dimensionless).

The above formula can be rewritten in conventional form as the Darcy radial flow equation and visco-skin:

$${Q}_{o} = \frac{2 π Kh ( {p}_{e} - {p}_{w} )}{{μ}_{LO} {B}_{o} [ ln \frac{{r}_{e}}{{r}_{w}} + {s}_{vs} ]}$$

$${s}_{vs} = ln \frac{{r}_{e}}{{r}_{w}} \cdot [ \frac{{P}_{μ}}{Δ pf ( {P}_{μ} )} - 1 ]$$

where Bₒ is an oil-phase volume factor (dimensionless); and sᵥₛ is a visco-skin parameter (dimensionless).

Oil-phase velocity may be approximated as the product of oil saturation and Darcy flow velocity. Under oil shale formation conditions and according to the visco-skin concept, defining oil saturation at the wellbore as 1 establishes a functional relationship between oil saturation and pressure:

$$\vec{{v}_{o}} = \frac{p ( r ) - {p}_{w}}{p ( r )} \times {u}_{o}$$

where uₒ is Darcy flow velocity (unit: m/s).
(4) Internal Heat Source Intensity Integral Calculation: In a cylindrical coordinate system, the energy distribution generated radially by the current excited via in-situ electrical heating in the well is given by:

$${Q}_{e} = {\int }_{{r}_{w}}^{{r}_{e}} 2 π rh σ ( r ) {( \frac{\partial Ψ ( r )}{\partial r} )}^{2} dr$$

where Qₑ is energy distribution generated in the radial direction (unit: J); σ(r) is electrical conductivity distribution in the radial direction (unit: S/m); and Ψ(r) is electric potential distribution in the radial direction (unit: V).

Performing a surface integral of the radial energy distribution within the cross-section yields energy distribution generated at any height:

$${Q}_{A} = {\int }_{0}^{2 π} {\int }_{{r}_{w}}^{{r}_{e}} 2 π rh σ ( r , θ ) {( \frac{\partial Ψ ( r , θ )}{\partial r} )}^{2} dr d θ$$

where Q_{A} is energy distribution generated on the cross-section (unit: J); σ(r, θ) is electrical conductivity distribution on the cross-section (unit: S/m); and Ψ(r, θ) is electric potential distribution on the cross-section (unit: V).

Alternatively, performing a surface integral of the radial energy distribution within the longitudinal section yields energy distribution generated in any angular direction:

$${Q}_{L} = {\int }_{0}^{h} {\int }_{{r}_{w}}^{{r}_{e}} 2 π rh σ ( r , z ) {( \frac{\partial Ψ ( r , z )}{\partial r} )}^{2} dr dz$$

where Q_{L} is energy distribution generated on the vertical cross-section (unit: J); σ(r, z) is electrical conductivity distribution on the vertical cross-section (unit: S/m); and Ψ(r, z) is electric potential distribution on the vertical cross-section (unit: V).

Further integrating the surface integral result over the volume integral yields energy distribution generated in the entire space:

$${Q}_{V} = {\int }_{0}^{h} {\int }_{0}^{2 π} {\int }_{{r}_{w}}^{{r}_{e}} 2 π rh σ ( r , z , θ ) {( \frac{\partial Ψ ( r , z , θ )}{\partial r} )}^{2} dr d θ dz$$

where Qᵥ is energy distribution generated in the spatial domain (unit: J); σ(r, z, θ) is electrical conductivity distribution in the spatial domain (unit: S/m); and Ψ(r, z, θ) is electric potential distribution in the spatial domain (unit: V).
(5) Mathematical Physics Equation Integral Solving: based on requirements of the actual physical model, initial conditions and boundary conditions are established. The oil-phase velocity and internal heat source intensity formulas are substituted into the convection-heat conduction equation. Temperature distribution formulas for in-situ electrical heating under visco-skin influence are obtained through integral solving.

Calculation example: a three-dimensional cylindrical longitudinal section is selected as an example. The transverse length of the longitudinal section is set to 10 m, the longitudinal length to 10 m, and the well radius to 0.1 m, with the assumption that temperatures across the entire wellhead are equal (as shown in FIG. 4).

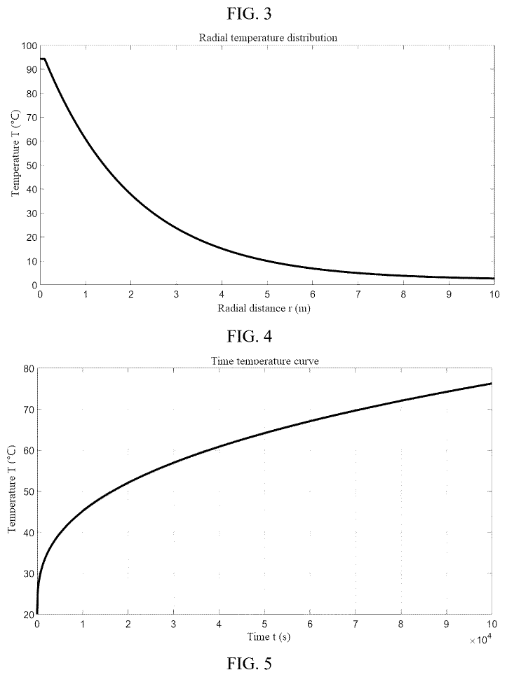

Under the premise of neglecting the influence of upper and lower surrounding rocks and assuming adiabatic conditions at both upper and lower boundaries, we obtain: temperature distribution diagram of the longitudinal section (as shown in FIG. 3), radial temperature distribution diagram (as shown in FIG. 4), and time-temperature curve diagram at any point (as shown in FIG. 5). FIG. 3 and FIG. 4 display temperature distributions at a specific time instant, while FIG. 5 selects the central point of the model as a representative point to plot the time-temperature curve.

From the temperature distribution diagram of the longitudinal section, radial temperature distribution diagram, and time-temperature curve diagram at a point, it can be determined that temperature increases with prolonged time and decreases with radial depth, consistent with physical laws.

A temperature distribution calculation system for in-situ electrical heating of a reservoir, comprising: a model construction module configured to establish a physical formation model of a formation in a near-wellbore zone; and constructing a mathematical physical equation for heat conduction and heat convection phenomena in the formation based on said physical formation model and the law of energy conservation; a parameter calculation module configured to calculate oil-phase flow velocity data within said physical formation model and calculate internal heat source intensity distribution data generated by in-situ electrical heating within said physical formation model; a temperature distribution calculation module configured to substitute said oil-phase flow velocity data and said internal heat source intensity distribution data into said mathematical physics equation, and acquire temperature distribution data of the formation through integral solving.

An electronic device comprising a memory and a processor, wherein said memory is configured to store a computer program, and said processor is configured to execute said computer program to cause said electronic device to perform said method for calculating temperature distribution in in-situ electrical heating of a reservoir.

A computer-readable storage medium storing a computer program which, when executed by a processor, implements said method for calculating temperature distribution in in-situ electrical heating of a reservoir.

While the present invention has been described in connection with specific embodiments, it is understood that alternative implementations, modifications, and equivalents will be apparent to those skilled in the art. Such variations are encompassed within the scope of the invention as set forth in the appended claims and their legal equivalents

What is claimed is:

1. A method for calculating temperature distribution in in-situ electrical heating of a reservoir, wherein the method comprises:
establishing a physical formation model of a formation in a near-wellbore zone;
constructing a mathematical physics equation for heat conduction and heat convection phenomena in the formation based on said physical formation model, and in combination with the law of energy conservation:
$$ρ c \frac{\partial T}{\partial t} + {ρ}_{o} {c}_{o} \vec{{v}_{o}} ∇ T = ∇ \cdot ( k ∇ T ) + Q$$
where ρ is formation rock density, c is formation rock specific heat capacity, T is formation temperature after heating time t, ρₒ is oil density, cₒ is oil specific heat capacity, \vec{vₒ} is oil-phase flow velocity, k is thermal conductivity, and Q is internal heat source intensity of the formation, with the physical meaning of heat absorbed per unit volume per unit time;
calculating oil-phase flow velocity data within said physical formation model:
$$\vec{{v}_{o}} = \frac{p ( r ) - {p}_{w}}{p ( r )} \times {u}_{o}$$
where \vec{vₒ} is oil-phase flow velocity, p(r) is pressure distribution in the radial direction, p_{w} is pressure at the wellbore, and uₒ is Darcy flow velocity;
calculating internal heat source intensity distribution data generated by in-situ electrical heating within said physical formation model;
substituting said oil-phase flow velocity data and said internal heat source intensity distribution data into said mathematical physical equation, and acquiring temperature distribution data of the formation through integral solving.

2. The method for calculating temperature distribution in in-situ electrical heating of a reservoir according to claim 1, wherein establishing the physical formation model of the formation in the near-wellbore zone specifically comprises:
determining model construction parameters, said model construction parameters comprising geometric dimensions, boundary conditions, and physical properties of formation materials of the near-wellbore zone formation;
establishing said physical formation model based on the determined model construction parameters.

3. The method of claim 1, wherein calculating internal heat source intensity distribution data generated by in-situ electrical heating within said physical formation model comprises:
determining conductivity distribution data and electric potential distribution data in radial direction, cross-section, and longitudinal section within said physical formation model;
calculating energy distribution data generated in radial direction, cross-section, and longitudinal section within said physical formation model based on said electrical conductivity distribution data and said electric potential distribution data;
performing surface and volume integration on the calculated energy distribution data to obtain internal heat source intensity distribution data in space within said physical formation model.

4. A temperature distribution calculation system for in-situ electrical heating of a reservoir, characterized by comprising:
a model construction module configured to establish a physical formation model of a formation in a near-wellbore zone; and
constructing a mathematical physical equation for heat conduction and heat convection phenomena in the formation based on said physical formation model and the law of energy conservation:
$$ρ c \frac{\partial T}{\partial t} + {ρ}_{o} {c}_{o} \vec{{v}_{o}} ∇ T = ∇ \cdot ( k ∇ T ) + Q$$
where ρ is formation rock density, c is formation rock specific heat capacity, T is formation temperature after heating time t, ρₒ is oil density, cₒ is oil specific heat capacity, \vec{vₒ} is oil-phase flow velocity, k is thermal conductivity, and Q is internal heat source intensity of the formation, with the physical meaning of heat absorbed per unit volume per unit time;
a parameter calculation module configured to calculate oil-phase flow velocity data within said physical formation model:
$$\vec{{v}_{o}} = \frac{p ( r ) - {p}_{w}}{p ( r )} \times {u}_{o}$$
where \vec{vₒ} is oil-phase flow velocity, p(r) is pressure distribution in the radial direction, p_{w} is Pressure at the Wellbore, and uₒ is Darcy Flow Velocity;
calculating internal heat source intensity distribution data generated by in-situ electrical heating within said physical formation model;
a temperature distribution calculation module, configured to substitute said oil-phase flow velocity data and said internal heat source intensity distribution data into said mathematical physics equation, and acquire temperature distribution data of the formation through integral solving.
